(19) United States
(12) Patent Application Publication
(10) Pub. No.: US 2013/0336357 A1
(43) Pub. Date: Dec. 19, 2013

(54) SYSTEM AND METHOD FOR BODY TEMPERATURE MEASUREMENT

(71) Applicant: Yousef ISSA, Tel Aviv (IL)

(72) Inventor: Yousef ISSA, Tel Aviv (IL)

(21) Appl. No.: 13/526,990

(22) Filed: Jun. 19, 2012

(51) Int. Cl. G01K 7/16

(52) U.S. Cl. 374/143; 374/142; 374/170; 374/E07.018

(57) ABSTRACT

The invention provides for highly accurate body temperature measurement by use of a temperature-dependent resistor such as an RTD or thermistor of minimal thermal mass, in thermal contact with an easy-to-access body location such as the earlobe. This resistance is connected as one leg of a Wheatstone Bridge and hence to an instrumentation amplifier and A-D circuit. Datalogging is provided as well as wireless transmission means allowing for remote data display and analysis.

### BACKGROUND

1. Technical Field

Embodiments of the present invention relate generally to systems and methods for accurate measurement of body temperature.

2. Description of Related Art

Temperature control (thermoregulation) is part of the vitally important homeostatic mechanism in warm-blooded organisms that keeps the organism at optimum operating temperature, radically affecting the rates of chemical reactions.

Thus body temperature measurement can be of critical importance in the diagnosis and treatment of a wide range of conditions and diseases. For example one symptom of swine flu is a marked decrease in body temperature.

‘Normal’ human body temperature depends upon the place in the body at which the measurement is made, and a host of other factors including time of day, level of activity of the person, hunger or satiation, alertness, and so on. No single number represents normal or healthy temperature for all subjects for a given place of measurement; rather there are averages such as 36.8°±0.4° C., the average oral temperature. The average core body temperature (taken internally) is 37.5° C.

As mentioned various body parts will generally have different temperatures. Rectal and vaginal measurements, or other measurements taken directly inside the body cavity, are typically slightly higher than oral measurements, which are in turn higher than skin temperature. Other measurement locations include under the armpit (axillary measurement), in the ear, and on the forehead. Generally, oral, rectal, gut, and core body temperatures, although slightly different, are well-correlated, with oral temperature being the lowest of the four, and with the peak daily temperature for axillary measurements lagging about three hours behind the rest of the body.

Axillary (armpit), tympanic (ear), and other skin-based temperatures correlate relatively poorly with core body temperature. Tympanic measurements are higher than rectal and core body measurements, and axillary temperatures lower. The body uses the skin as a tool to increase or decrease core body temperature, which affects the temperature of the skin, thus skin temperatures are more variable than other sites. Skin temperatures are also more influenced by outside factors, such as clothing and air temperature. Normal healthy averages for various locations are listed below:

| | Normal average |
|---|---|
| Location | temperature |
| Anus | 37.5° C. |
| Vagina | 37.5° C. |
| Ear | 37.5° C. |
| Mouth | 37.0 ± 0.5° C. |
| Under arm (maxillary) | 36.5° C. |

The normal human body temperature can fluctuate about one ½ degree (C.) diurnally with lower temperatures in the morning and higher temperatures in the late afternoon and evening; the normally quoted average temperature range is 36.1 C to 37.2 C. Thus an oral temperature of 37.2° C. (99.0° F.) is normal in the afternoon but not in the morning. To make matters even more complex oral temperatures are influenced by drinking, chewing, smoking, and mouth breathing. Cold drinks or food reduce oral temperatures; hot drinks, hot food, chewing, and smoking raise them.

Variations in body temperature are part of the circadian rhythm; time of day, hunger, alertness and other circumstances also affect the body's temperature. The human diurnal variation for example may range several degrees. Body temperature is also sensitive to hormones; women have a temperature rhythm that varies with the menstrual cycle. A woman's basal body temperature rises sharply after ovulation, as estrogen production decreases and progesterone increases. Fertility awareness programs use this predictable change to identify when a woman is able to become pregnant. Hormonal contraceptives raise the typical body temperature by about 0.6° C.

Temperature also varies with the year, and people living in different climates may have different seasonal patterns. Interestingly, increased physical fitness increases the amount of daily variation in temperature.

Temperature is increased after eating or drinking anything with calories. Caloric restriction, as for a weight-loss diet, reduces overall body temperature. Drinking alcohol reduces the amount of daily change, slightly lowering daytime temperatures and noticeably raising nighttime temperatures.

Exercise raises body temperatures. In adults, a noticeable increase usually requires strenuous exercise or exercise sustained over a significant time. Children develop higher temperatures with milder activities, like playing.

Psychological factors also influence body temperature; an excited person often has an elevated temperature.

Sleep disturbances also affect temperatures. Normally, body temperature drops significantly at a person's normal bedtime and throughout the night. Short-term sleep deprivation produces a higher temperature at night than normal while long-term sleep deprivation reduces temperatures. Waking up unusually early, sleeping in, jet lag and changes to schedules may affect body temperature.

Standard temperature values are generally taken of an otherwise healthy, non-fasting adult, dressed comfortably and indoors, in a room that is kept at a ‘normal’ room temperature (22.7 to 24.4° C.), and during the morning but not shortly after arising from sleep. For oral temperatures, the subject must not have eaten, drunk, or smoked anything in at least the previous fifteen to twenty minutes.

When the setpoint of the body's thermoregulation is raised, the result is a fever. Most fevers are caused by infectious disease and can be lowered, if desired, with antipyretic medications. An a.m. temperature of >37.2° C. or a p.m. temperature of >37.7° C. constitutes fever, technically related but different than hyperthermia (e.g. heat stroke) insofar as the former is caused by the body's own regulation mechanisms while the latter is an overpowering of the body's regulation.

Hyperthermia occurs when the body produces or absorbs more heat than it dissipates; this can be caused (for instance) by prolonged exposure to high temperatures. The heat-regulating mechanisms of the body eventually become overwhelmed and unable to deal effectively with the heat, causing the body temperature to climb uncontrollably. Hyperthermia at or above about 40° C. is a life-threatening medical emergency that requires immediate treatment with symptoms include headache, confusion, and fatigue.

Likewise hypothermia involves body temperatures below that required for normal metabolism and bodily functions, usually due to excessive exposure to cold air or water.

The human body can withstand a small range of temperature variation, which when exceeded may lead to serious problems as listed in the following table:

| | |
|---|---|
| 36.1-37.5° C. | Normal body temperature |
| 38° C. | Sweating, feeling very uncomfortable, slightly hungry. |
| 39° C. | Severe sweating, flushed and very red. Fast heart rate and |
| | breathlessness. There may be exhaustion accompanying this. Children |
| | and people with epilepsy may be very likely to get convulsions at this |
| | point. |
| 40° C. | Fainting, dehydration, weakness, vomiting, headache and dizziness |
| | may occur as well as profuse sweating. Starts to be life-threatening. |
| 41° C. | (Medical emergency) - Fainting, vomiting, severe headache, dizziness, |
| | confusion, hallucinations, delirium and drowsiness can occur. There |
| | may also be palpitations and breathlessness. |
| 42° C. | Subject may turn pale or remain flushed and red. They may become |
| | comatose, be in severe delirium, vomiting, and convulsions can occur. |
| | Blood pressure may be high or low and heart rate will be very fast. |
| 43° C. | Normally death, or there may be serious brain damage, |
| | continuous convulsions and shock. Cardio-respiratory collapse will |
| | likely occur |

Similarly the human body has a relatively small range of temperatures through which it may drop without serious complications, as illustrated by the following table:

| | |
|---|---|
| 36.1-37.5° C. | Normal body temperature |
| 36° C. | Mild to moderate shivering (body temperature may drop this low |
| | during sleep). May be a normal body temperature. |
| 35° C. | (Hypothermia) is less than 35° C. (95° F.) - Intense shivering, numbness |
| | and bluish/grayness of the skin. There is the possibility of heart |
| | irritability. |
| 34° C. | Severe shivering, loss of movement of fingers, blueness and confusion. |
| | Some behavioural changes may take place. |
| 33° C. | Moderate to severe confusion, sleepiness, depressed reflexes, |
| | progressive loss of shivering, slow heart beat, shallow breathing. |
| | Shivering may stop. Subject may be unresponsive to certain stimuli. |
| 32° C. | (Medical emergency) Hallucinations, delirium, complete confusion, |
| | extreme sleepiness that is progressively becoming comatose. Shivering |
| | is absent (subject may even think they are hot). Reflex may be absent |
| | or very slight. |
| 31° C. | Comatose, very rarely conscious. No or slight reflexes. Very shallow |
| | breathing and slow heart rate. Possibility of serious heart rhythm |
| | problems. |
| 28° C. | Severe heart rhythm disturbances are likely and breathing may stop at |
| | any time. Patient may appear to be dead. |

Temperature examination in the rectum is the traditional gold standard measurement used to estimate core temperature (oral temperature is affected by hot or cold drinks and mouth-breathing).

Since the turn of the millennium, small ear thermometers have become available and it is thought that the eardrum closely mirrors core temperature values. These works by detecting the infrared heat emission from the tympanic membrane and a measurement is quickly taken. While the electronic display of the temperature value is easier to read than interpreting the graduation marks on a thermometer, there are some concerns for the accuracy of ear thermometers in home use; this method of measuring body temperature is not as accurate as rectal measurement and has a low sensitivity for fevers, missing three or four out of every ten fevers in children. Infrared ear temperature measurement may be acceptable for observing trends in body temperature but is less useful in consistently identifying fevers.

Currently body temperature measurement is generally carried out using sealed glass oral or rectal thermometers, metal oral thermometers, or infrared ear thermometers, each of which have certain drawbacks. Glass thermometers may break, with possible injury or poisoning as a result; there is a risk of injury from cracking glass thermometers if too much force is applied by the teeth to hold them in place and the alcohol or mercury contents are poisonous. This is avoided by the use of electronic thermometers which are made from solid plastic and use a metal (thermocouple) sensor.

The use of electronic thermometers which are made from solid plastic and use a metal (thermocouple) sensor has raised concerns about the accuracy thereof, as is likewise the case for infrared ear thermometers as mentioned above. Furthermore the results of all these probes are generally accessed by reading a display or gauge, a method requiring manual attention is generally in short supply in the hospital setting.

Hence, an improved method for temperature measurement is still a long felt need.

### BRIEF SUMMARY

According to an aspect of the present invention, there is provided a system and method for precise body temperature measurement and reporting.

It is within provision of the invention to provide a body temperature measuring device comprising:
a. a temperature-dependent resistor in thermal contact with a body part;
b. a Wheatstone bridge comprising a plurality of fixed resistors and said temperature-dependent resistor;
c. an exciting voltage source providing voltage to said Wheatstone bridge;
d. an instrumentation amplifier in electrical contact with the bridge of said Wheatstone bridge;
e. analog-to-digital conversion means in electrical contact with the output of said instrumentation amplifier;
f. data transmission means in electrical contact with said analog-to-digital conversion means;
whereby highly sensitive temperature measurements may be performed with a minimum of attention.

It is further within provision of the device comprising data storage means adapted to log the readings of said analog-to-digital conversion means.

It is further within provision of the device comprising sensing means adapted to sense parameters selected from the list consisting of: blood CO2 level, blood O2 level, blood pressure, blood flow rate.

It is further within provision of the device wherein said data transmission means is IEEE 802.11 compliant.

It is further within provision of the device wherein said data transmission means is Bluetooth compliant.

It is further within provision of the device comprising alarm means adapted to sound when said temperature measuring device measures a temperature outside a predetermined temperature window.

It is further within provision of the device wherein said temperature window has a lower bound of about 36° C.

It is further within provision of the device wherein said temperature window has an upper bound of about 38° C.

It is further within provision of the device wherein said alarm is adapted to send an alarm signal over said data transmission means.

It is within provision of the invention to provide a method for measurement of body temperature comprising steps of:
a. putting a temperature-dependent resistor into thermal contact with a body part;
b. connected said temperature-dependent resistor as one leg of a Wheatstone bridge comprising a plurality of fixed resistors and said temperature-dependent resistor;
c. impressing voltage upon said Wheatstone bridge by means of a voltage source;
d. amplifying the output of said Wheatstone bridge an instrumentation amplifier in electrical contact with the bridge of said Wheatstone bridge;
e. analog-to-digital conversion means in electrical contact with the output of said instrumentation amplifier;
f. data transmission means in electrical contact with said analog-to-digital conversion means;
whereby highly sensitive temperature measurements may be performed with a minimum of attention.

It is further within provision of the invention comprising data storage means adapted to log the readings of said analog-to-digital conversion means.

It is further within provision of the invention comprising sensing means adapted to sense parameters selected from the list consisting of: blood CO2 level, blood O2 level, blood pressure, blood flow rate.

It is further within provision of the invention wherein said data transmission means is IEEE 802.11 compliant.

It is further within provision of the invention wherein said data transmission means is Bluetooth compliant.

It is further within provision of the invention further comprising alarm means adapted to sound when said temperature measuring device measures a temperature outside a predetermined temperature window.

It is further within provision of the invention wherein said temperature window has a lower bound of about 36° C.

It is further within provision of the invention wherein said temperature window has an upper bound of about 38° C.

It is further within provision of the invention wherein said alarm is adapted to send an alarm signal over said data transmission means.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates a possible system diagram of the invention.

### DETAILED DESCRIPTION

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a system and method for.

In the following detailed description, numerous specific details are set forth in order to provide a thorough understanding of embodiments of the present invention. However, those skilled in the art will understand that such embodiments may be practiced without these specific details. Furthermore just as every particular reference may embody particular methods, but yet not require such, ultimately such teaching is meant for all expressions notwithstanding the use of particular embodiments. Reference throughout this specification to “one embodiment” or “an embodiment” means that a particular feature, structure, or characteristic described in connection with the embodiment is included in at least one embodiment of the invention.

The term ‘plurality’ refers hereinafter to any positive integer (e.g, 1, 5, or 10).

Body temperature is a complex phenomenon that can be of key importance in diagnosis and treatment of various conditions. Thus rapid, accurate measurement thereof is a basic requirement of hospital settings. The ease of reading and inconspicuousness of the sensor also are of practical consequence for long term and high usage settings as in hospitals, hospices, long term care and the like.

In the introduction a number of extant method and the drawbacks thereof were discussed. In light of these compounded difficulties, a felicitous solution has been created within provision of the current invention, namely the use of a temperature sensor of minimal thermal mass in contact with an easy-to-access body location such as the earlobe, which exploits the exquisite sensitivity of the ‘Wheatstone Bridge’ for purposes of highly accurate measurement. Such a circuit may use a bridge device as known in the art. One key advantage of this circuit is that finite input impedance of the voltmeter used will not appreciably affect the results.

Elementary circuit theory may be applied to arrive at the result that the resistance of the sense resistor R_{T} is given by:

$${R}_{T} = {R}_{1} ( \frac{{ER}_{2} - Δ V ( {R}_{1} + {R}_{2} )}{{ER}_{1} + Δ V ( {R}_{1} + {R}_{2} )} )$$

This resistance is of course used for measurement purposes, for instance comprising a thermistor or RTD (resistive temperature device) or the like.

In the case of an RTD the temperature dependence is linear

In the case of a thermistor, high response amplitude may be achieved in limited ranges due to the exponential dependence of resistance upon temperature:

$${R}_{T} = {R}_{0} exp ( β [ \frac{1}{T} - \frac{1}{{T}_{0}} ] )$$

which can be rewritten as

$$\frac{1}{T} = \frac{1}{{T}_{0}} + \frac{1}{β} ln ( \frac{{R}_{T}}{{R}_{0}} )$$

As should be clear, the proportional change in resistance is much greater in large ranges for the thermistor and hence its signal will be much greater than that of the RTD. Furthermore the region of largest sensitivity can be tailored as the factors R₀ and β may be controlled by choice of thermistor.

The signal amplitude is of course important but the signal to noise ratio may be of more relevance when measuring small signals, especially given that the amplitude may be increased arbitrarily in the Wheatstone bridge by simply increasing the exciting voltage. The error will be generated by several sources including shot noise, thermal (Johnson) noise, pickup, and other sources.

The thermal noise has a linear resistance dependence, and thus the increase of the signal strength in fact does not affect the SNR:

<V²>=4k_{B}TRΔf

In any case the invention comprises use of either the RTD, thermistor, shot-noise thermometer, or other element in thermal contact with the body at some appropriate point such as the ear, coupled to a high-accuracy measurement circuit such as the Wheatstone bridge, allowing accurate amplification of small voltages.

It is within provision of the invention that data logging be undertaken on the device itself for purposes of long-term analyses of patient data.

It is within provision of the invention that wireless transmission means be provided such that the device of the invention may transmit data wirelessly, for example over a Bluetooth or other wireless network, to a receiving unit in communication with display means, for example a smartphone.

It is within provision of the invention that various other sensors e provided with the circuits of the device such as an oxygen saturation sensor, CO2 level sensor, and the like. These data may be recorded and/or sent wirelessly as well, allowing for a fuller picture of patient health to be determined.

It is within provision of the invention that alarm means be employed to alert physicians and other personnel when dangerous temperature related conditions occur. For instance a klaxon may sound when the temperature measured rises above 38° C. or below 36° C.

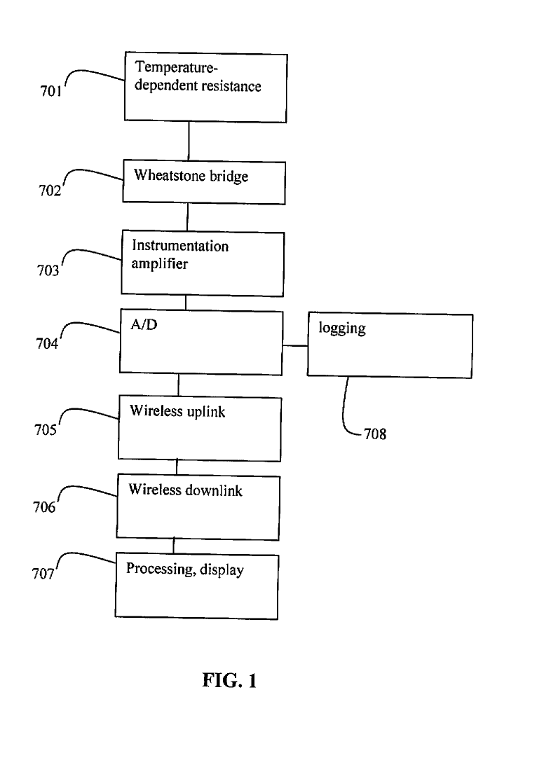

A simplified system diagram is shown in FIG. 1. Here one sees the temperature dependent resistance 701 which will generally be put into thermal contact with the earlobe or other easy to access body part, for instance attached by means of a clip allowing hands-free operation. The resistance 701 is configured as part of a Wheatstone bridge 702 allowing direct measurement of a voltage instead of a resistance. This voltage is read by the instrumentation amplifier 703 whose output is fed to an analog-digital converter 704. The values are then optionally stored 708 and sent thru a wireless uplink. The data are received by any suitable wireless downlink 706 which for instance may comprises a smartphone, and the data are then processed and/or displayed, sent over a network, saved, etc.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

What is claimed is:

1. A body temperature measuring device comprising:
a temperature-dependent resistor in thermal contact with a body part;
a Wheatstone bridge comprising a plurality of fixed resistors and said temperature-dependent resistor;
an exciting voltage source providing voltage to said Wheatstone bridge;
an instrumentation amplifier in electrical contact with the bridge of said Wheatstone bridge;
analog-to-digital conversion means in electrical contact with the output of said instrumentation amplifier;
data transmission means in electrical contact with said analog-to-digital conversion means;
whereby highly sensitive temperature measurements may be performed with a minimum of attention.

2. The device of claim 1 further comprising data storage means adapted to log the readings of said analog-to-digital conversion means.

3. The device of claim 1 further comprising sensing means adapted to sense parameters selected from the list consisting of: blood CO2 level, blood O2 level, blood pressure, blood flow rate.

4. The device of claim 1 wherein said data transmission means is IEEE 802.11 compliant.

5. The device of claim 1 wherein said data transmission means is Bluetooth compliant.

6. The device of claim 1 further comprising alarm means adapted to sound when said temperature measuring device measures a temperature outside a predetermined temperature window.

7. The device of claim 6 wherein said temperature window has a lower bound of about 36° C.

8. The device of claim 6 wherein said temperature window has an upper bound of about 38° C.

9. The device of claim 6 wherein said alarm is adapted to send an alarm signal over said data transmission means.

10. A method for measurement of body temperature comprising steps of:
putting a temperature-dependent resistor into thermal contact with a body part;
connected said temperature-dependent resistor as one leg of a Wheatstone bridge comprising a plurality of fixed resistors and said temperature-dependent resistor;
impressing voltage upon said Wheatstone bridge by means of a voltage source;
amplifying the output of said Wheatstone bridge an instrumentation amplifier in electrical contact with the bridge of said Wheatstone bridge;
analog-to-digital conversion means in electrical contact with the output of said instrumentation amplifier;
data transmission means in electrical contact with said analog-to-digital conversion means;
whereby highly sensitive temperature measurements may be performed with a minimum of attention.

11. The method of claim 10 further comprising data storage means adapted to log the readings of said analog-to-digital conversion means.

12. The method of claim 10 further comprising sensing means adapted to sense parameters selected from the list consisting of: blood CO2 level, blood O2 level, blood pressure, blood flow rate.

13. The method of claim 10 wherein said data transmission means is IEEE 802.11 compliant.

14. The method of claim 10 wherein said data transmission means is Bluetooth compliant.

15. The method of claim 10 further comprising alarm means adapted to sound when said temperature measuring device measures a temperature outside a predetermined temperature window.

16. The method of claim 16 wherein said temperature window has a lower bound of about 36° C.

17. The method of claim 16 wherein said temperature window has an upper bound of about 38° C.

18. The method of claim 16 wherein said alarm is adapted to send an alarm signal over said data transmission means.
